(19) United States
(12) Patent Application Publication
(10) Pub. No.: US 2019/0283531 A1
(43) Pub. Date: Sep. 19, 2019

(54) INTELLIGENT THERMAL CONTROL SYSTEM FOR AUTONOMOUS VEHICLE

(71) Applicant: Air International Thermal Systems, Auburn Hills, MI (US)

(72) Inventor: Joseph J. Spryshak, Hartland, MI (US)

(73) Assignee: Air International Thermal Systems, Auburn Hills, MI (US)

(21) Appl. No.: 16/357,129

(22) Filed: Mar. 18, 2019

Related U.S. Application Data
(60) Provisional application No. 62/644,434, filed on Mar. 17, 2018.

(51) Int. Cl. B60H 1/00; B60H 1/24

(52) U.S. Cl. CPC B60H 1/00735; B60H 1/00021; B60H 1/00742; B60H 1/0075; B60H 1/00764; B60H 1/24; B60H 1/00778; B60H 1/00785; B60H 1/00792; B60H 1/00878; B60H 1/00985; B60H 1/00771

(57) ABSTRACT

A thermal system for use in autonomous motor vehicles includes an intelligent controller that receives inputs from various sources, interprets the inputs using an algorithm that learns during the process of interpreting the inputs, and generates outputs to control system features. The intelligent controller receives key input data that includes internet data and vehicle data. This data, together with other key inputs, are provided to the input layer which determines an energy balance that identifies the desired power level and the actual power level. Once the desired and actual power levels are identified, the controller generates outputs that regulate conditions within the vehicle's interior. The intelligent controller includes algorithms that enable the thermal system to make power management predictions for maximum system efficiency. The intelligent controller is capable of learning and can make decisions as to optimum interior conditions without the need for additional or repetitive operator or occupant inputs.

### CROSS-REFERENCE TO RELATED APPLICATION

This application claims the benefit under 35 U.S.C. Section 119(e) of U.S. provisional application Ser. No. 62/644,434, filed Mar. 17, 2018, which is incorporated by reference herein in its entirety.

### TECHNICAL FIELD

The disclosed inventive concept relates generally to interior thermal systems for use in autonomous vehicles. More particularly, the disclosed inventive concept relates to interior thermal systems for autonomous vehicles that provide convenient and efficient thermal control with minimum effort on behalf of the vehicle operator. Interior thermal control is accomplished by an intelligent controller that receives inputs from various sources, interprets the inputs using an algorithm that learns during the process of interpreting the inputs, and generates outputs to control a variety of system features.

### BACKGROUND OF THE INVENTION

Most vehicles today include heating, ventilation, and air conditioning (HVAC) systems to regulate the interior environment of the automotive vehicle so as to provide optimum occupant comfort. Vehicle interior heating systems were relatively primitive when introduced as early as the 1920s, involving generally a simple door in the vehicle firewall that could regulate hot air from a plenum typically heated by the vehicle's exhaust. Cooling air generated by an air conditioning system appeared much later on the automotive scene, this delay being the result of the inherent complexities of the air conditioning system as compared with heating systems.

The typical HVAC system used today includes a user-operated climate controller in the form of a user interface and an HVAC module. The user interface provides a driver or passenger controller for selecting, for example, air temperature, air flow, and air direction. The HVAC module channels incoming ambient air through either a heater or evaporator core and into the vehicle interior by way of a number of air outlets. The flow of air through the HVAC module is regulated by flow control doors that are movable between open, closed, or blend positions.

The controller operates to control the HVAC module by way of a mechanical linkage, an electrical system, or some mixture of mechanical and electrical operation. Door movement is controlled by electrical actuators or servo or stepper motors. The speed of the airflow blower motor is conventionally regulated by the voltage across the blower motor being adjusted.

The controller may also be responsive to a variety of inputs to achieve maximum occupant comfort. Such inputs may include ambient air temperature and humidity to which the controller may also respond.

Known approaches to operating interior vehicle thermal systems have developed over time and represent important advancements since the earliest days of automobile design. However, with the advent of the autonomous vehicle, further changes will be needed that, in general, will give the vehicle operator and vehicle occupants operational freedom that is consistent with the operation of the autonomous vehicle.

Certain expectations will need to be met consistent with the overall concept of the autonomous vehicle. On the one hand, the autonomous vehicle occupant will generally expect complete comfort from initial occupancy to vehicle departure. Also consistent with the autonomous vehicle experience, the vehicle occupant will not want to interact with vehicle controls or will only want the most minimal involvement with vehicle controls, including HVAC controls. The occupant will also want to have individual preferences achieved, such as requiring that different thermal requests for different portions of the body (for example, whether or not the individual's arm is in the sun). Compounding the demands placed on thermal control systems for the autonomous vehicle is the fact that each individual has a different interpretation of comfort levels such as temperature based on variables such as age and gender.

In addition to providing an operator-input free thermal environment that provides optimum interior conditions for each individual vehicle occupant, the ideal autonomous vehicle thermal system will also need to respond to the fact that occupant positions of the autonomous vehicle will be less constrained. Possible seating positions will likely be much more flexible providing movement to a number of locations within the vehicle interior, thereby providing virtually any seating orientation. Such advances in interior thermal innovation must also be made against the backdrop of requiring energy usage that provides maximum vehicle range.

As in so many areas of vehicle technology there is always room for improvements related to the design of thermal systems for use in the autonomous vehicle.

### SUMMARY OF THE INVENTION

The disclosed inventive concept provides a thermal system for a vehicle that overcomes the challenges faced by designers of autonomous vehicles. While directed primarily at the autonomous vehicle, it is to be understood that the disclosed inventive concept may be adapted for use in a wide variety of vehicle applications and is not limited to use in the autonomous vehicle alone.

The thermal system of the disclosed inventive concept generally provides advancement in HVAC systems in vehicles, particularly in autonomous motor vehicles, and relates to an interior thermal system that provides convenient and efficient thermal control with minimum effort on behalf of the vehicle operator. Interior thermal control is accomplished by an intelligent controller that receives inputs from various sources, interprets the inputs using an algorithm that learns during the process of interpreting the inputs, and generates outputs to control a variety of system features.

The intelligent controller of the disclosed inventive concept is configured to receive data representing key inputs. The data can be generally grouped as internet data and vehicle data. This data, together with other key inputs, are provided to the input layer of the intelligent controller.

The input data is received and interpreted by the intermediate layer which determines an energy balance that identifies the desired power level and the actual power level based on various sources of power and various power demands. Once the desired power level and the actual power level are identified, the intelligent controller generates outputs that regulate conditions within the vehicle's interior.

The intelligent controller of the disclosed inventive concept includes algorithms that enable the thermal system to make power management predictions for maximum system efficiency. The intelligent controller is capable of learning and can thus make decisions as to optimum interior conditions without the need for additional or repetitive operator or occupant inputs.

The above advantages and other advantages and features will be readily apparent from the following detailed description of the preferred embodiments when taken in connection with the accompanying drawings.

### BRIEF DESCRIPTION OF THE DRAWINGS

For a more complete understanding of this invention, reference should now be made to the embodiments illustrated in greater detail in the accompanying drawings and described below by way of examples of the invention wherein:

FIG. 1 is a view of an idealized controller to receive operator input to manage the system of the disclosed inventive concept;

FIG. 2 illustrates the neural network of the intelligent controller of the disclosed inventive concept including an input layer, an output layer, and an intermediate layer;

FIG. 3 is a schematic illustrating the inputs, intermediate processing, and outputs of the intelligent controller of the disclosed inventive concept;

FIG. 4 is a diagrammatic perspective view of the interior of an autonomous vehicle having the thermal system of the disclosed inventive concept; and

FIG. 5 is a diagrammatic view of the interior of an autonomous vehicle having the thermal system of the disclosed inventive concept.

### DETAILED DESCRIPTION OF THE PREFERRED EMBODIMENT

In the following figures, the same reference numerals will be used to refer to the same components. In the following description, various operating parameters and components are described for different constructed embodiments. These specific parameters and components are included as examples and are not meant to be limiting.

According to the disclosed inventive concept, the thermal system requires minimal operator or user input to achieve maximum passenger comfort throughout the whole vehicle occupancy experience. The thermal system learns the desirable comfort range for given occupants and thus requires minimal input. The thermal system of the disclosed inventive concept is capable of managing power efficiently by being able to predict upcoming drive cycles and pre-conditioning the battery and the vehicle cabin while the system is charging, thereby decreasing power consumption while the vehicle is in operation and decreasing power usage while charging. Pre-conditioning of the cabin and the battery in anticipation of upcoming road loads and climate can reduce peak thermal capacity requirements during vehicle operation.

The thermal system of the disclosed inventive concept makes intelligent and learned decisions regarding various conditions, including such variables as HVAC modes, refrigerant flow, and the like.

The disclosed inventive concept provides several advantages over known systems which typically appear in the form of feedback control loops. The thermal system disclosed herein includes multiple input and multiple output controllers. The thermal system is capable of solving complex, nonlinear systems and incorporates evolving algorithms in the form of a neural network. The evolving or learning algorithms can self-improve based upon objectives initially set and can be expanded upon with more inputs and outputs. The learning process occurs without further inputs from the vehicle occupant. Accordingly, the occupant merely enters the vehicle and, based on previous experience with that individual and input regarding the ambient environment, the intelligent controller manages the vehicle environment entirely on its own for the duration of the driving experience without further occupant input.

The learning process also extends to an awareness of the habits of the user. For example, the intelligent controller is capable of learning the departure time(s) of the occupant(s) and for pre-conditioning the vehicle's cabin accordingly. This learned use pattern will also result in the vehicle anticipating a charge time to precondition the battery below the normal operating temperature prior to fast charging.

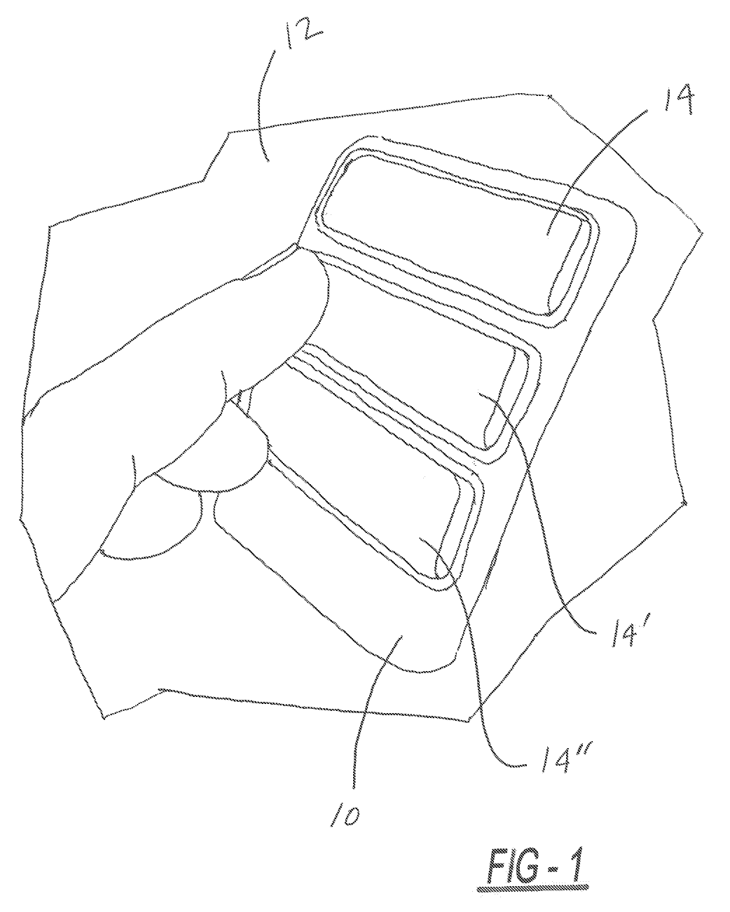

The education process of the intelligent controller is initiated by the vehicle occupants utilizing an input as illustrated in FIG. 1. Referring to that figure, an information input pad 10 is provided on the vehicle's instrument panel 12. Input selectors, such as input keys 14, 14′ and 14″, are provided for occupant selection of interior conditions, including, for example, cabin temperature, cabin humidity level, and blower speed. Once this information is entered, the occupant's identity is also entered. The intelligent controller thus has the necessary occupant information and can reference this information during subsequent trips without further occupant input.

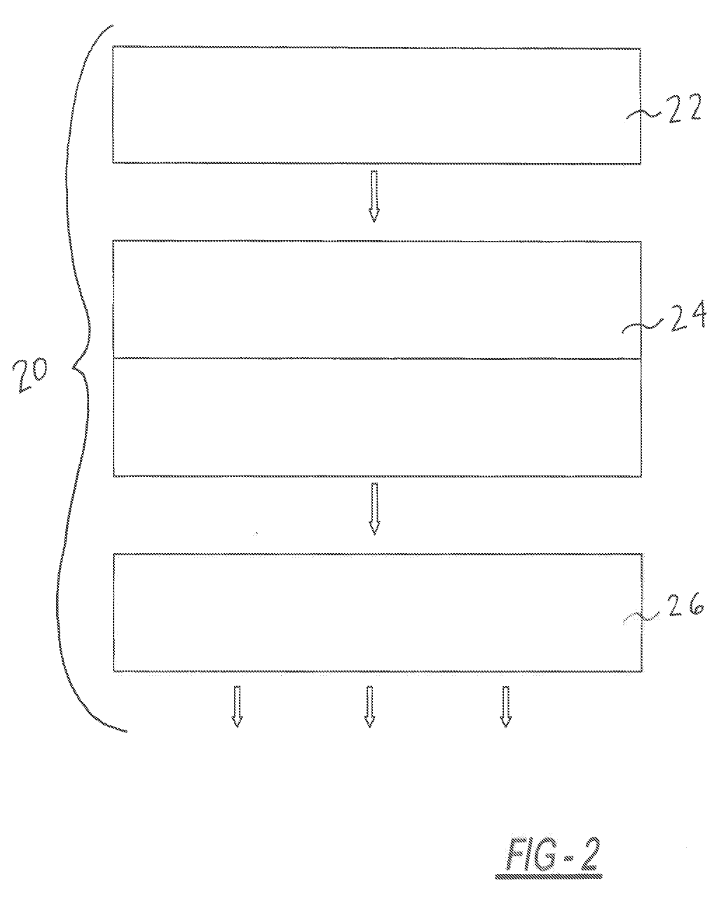

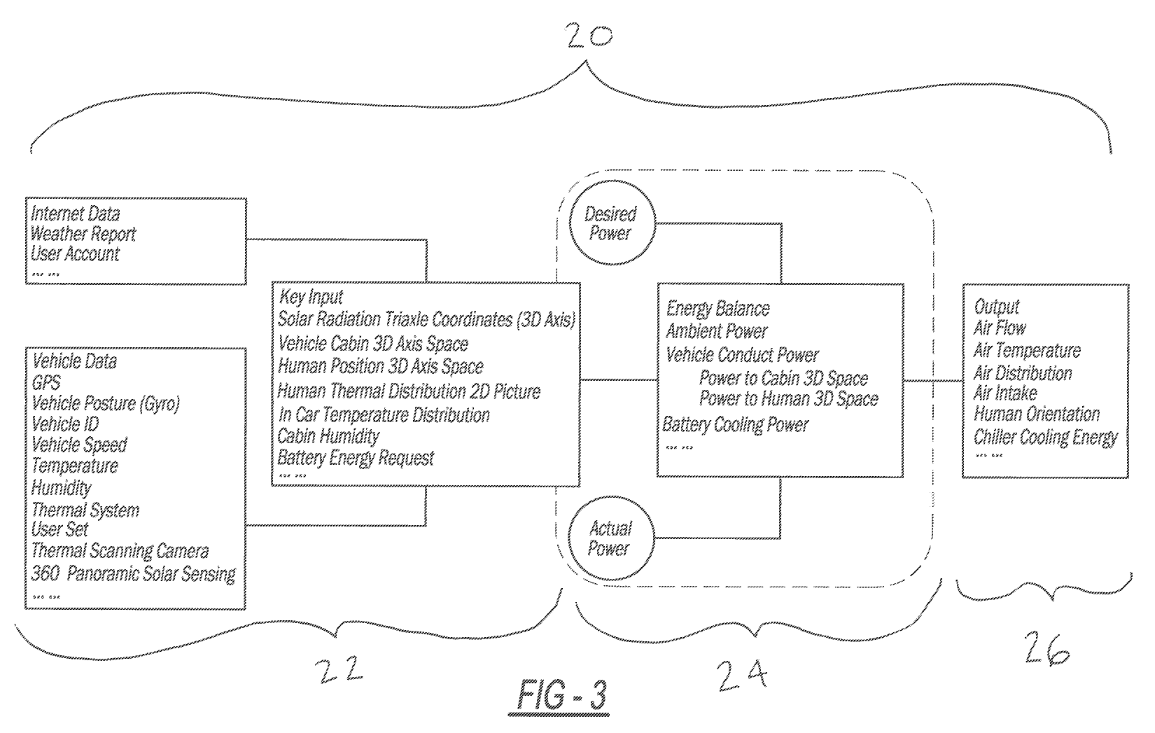

Referring to FIGS. 2 and 3, an intelligent controller is shown and is generally illustrated as 20. The intelligent controller 20 is illustrated in its idealized form in FIG. 2 and includes an input layer 22, an intermediate layer 24, and an output layer 26. The intelligent controller 20 includes appropriate software that, in addition to learning, reduces thermal loads wherever possible.

The input layer 22 of the intelligent controller 20 receives data representing key inputs. The data can be generally grouped as internet data and vehicle data. Internet data includes, without limitation and by way of example, weather conditions at the current vehicle position and at the current time as well as weather conditions throughout the journey and at the vehicle's destination accounting for travel time. Other internet input data can include ambient air quality conditions (to differentiate between air quality in a metropolitan environment vs. air quality in a rural environment) as well as road conditions such as road construction and traffic conditions (including any accident conditions) that may exist. Internet data may also include the operator's operating account. Knowledge of traffic information may be used in calculating drivetrain loads while knowledge of weather information may be used to anticipate upcoming climate loads, thereby allowing the pre-conditioning of the cabin while grid charging.

Vehicle data includes, again without limitation, the occupant's set preferences, vehicle position (based on GPS data), the vehicle's posture (the estimated posture of the vehicle as determined gyroscopically), the identification of the vehicle, the vehicle speed, ambient operating conditions such as temperature and humidity, and readings taken from vehicle interior sensors, such as a thermal scanning camera as well as a 360° panoramic solar sensor. The GPS data will allow intelligent controller 20 to anticipate upcoming drivetrain loads according to a given route terrain, thereby pre-conditioning component temperatures.

In addition to the internet data and the vehicle data referenced above, other inputs received by the input layer 22 of the intelligent controller 20 include, without limitation, solar radiation (as determined by triaxle coordinates [3D axis]), vehicle cabin and occupant positions (both by way of 3D axis space determination), occupant thermal distribution (by way of 2D imaging), cabin temperature distribution, cabin humidity, and batter power demands.

The input data received by the input layer 22 is received and interpreted by the intermediate layer 24. The received data is used by the intermediate layer 24 to determine an energy balance that identifies the desired power level and the actual power level based on various sources of power and various power demands. The energy balance is determined by various sensed conditions, including, but not limited to, ambient power, vehicle conduct or operating power (including the power to the cabin 3D space and the power to the occupant 3D space), and the battery cooling power.

Once the desired power level and the actual power level are identified at the intermediate layer 24, the intelligent controller 20 generates outputs that regulate conditions within the vehicle's interior. Such outputs include air output flow volume, air temperature, air flow distribution, and air intake volume. The outputs also include regulation of energy flow, such as the amount of chiller cooling energy needed.

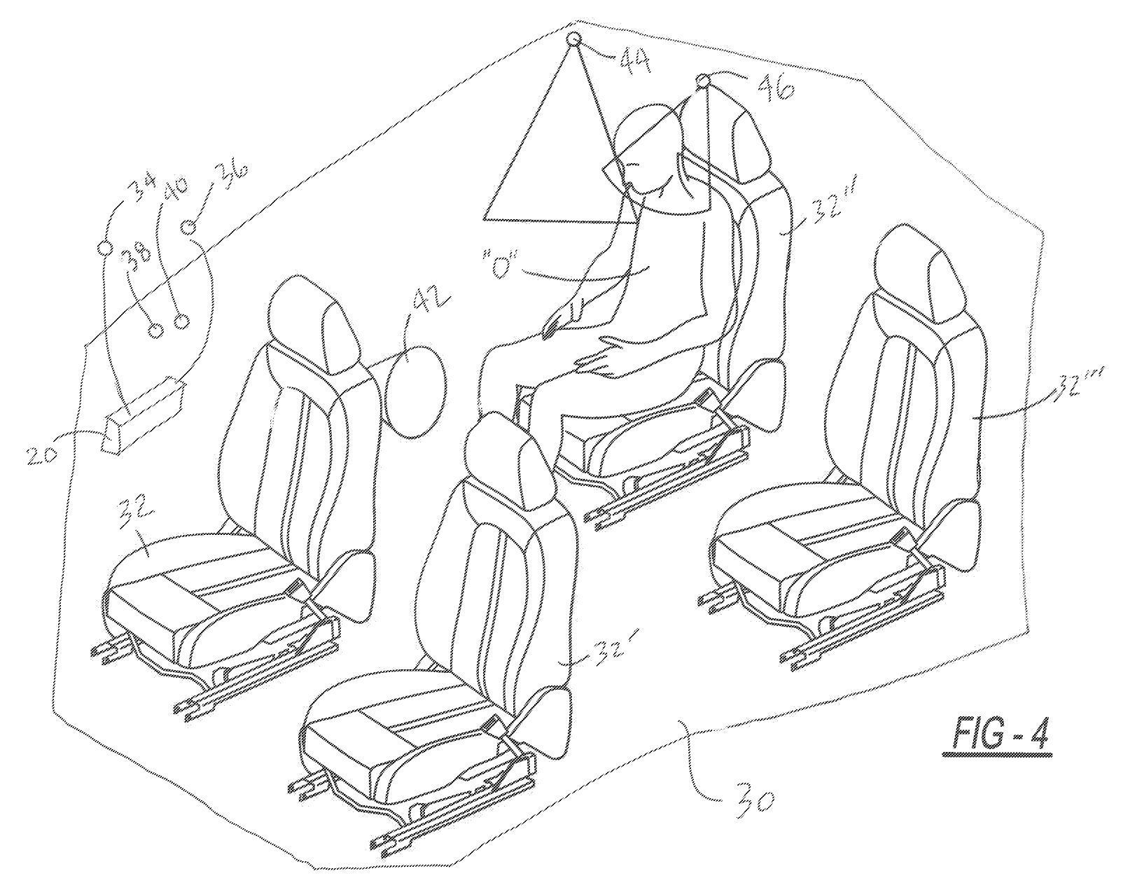

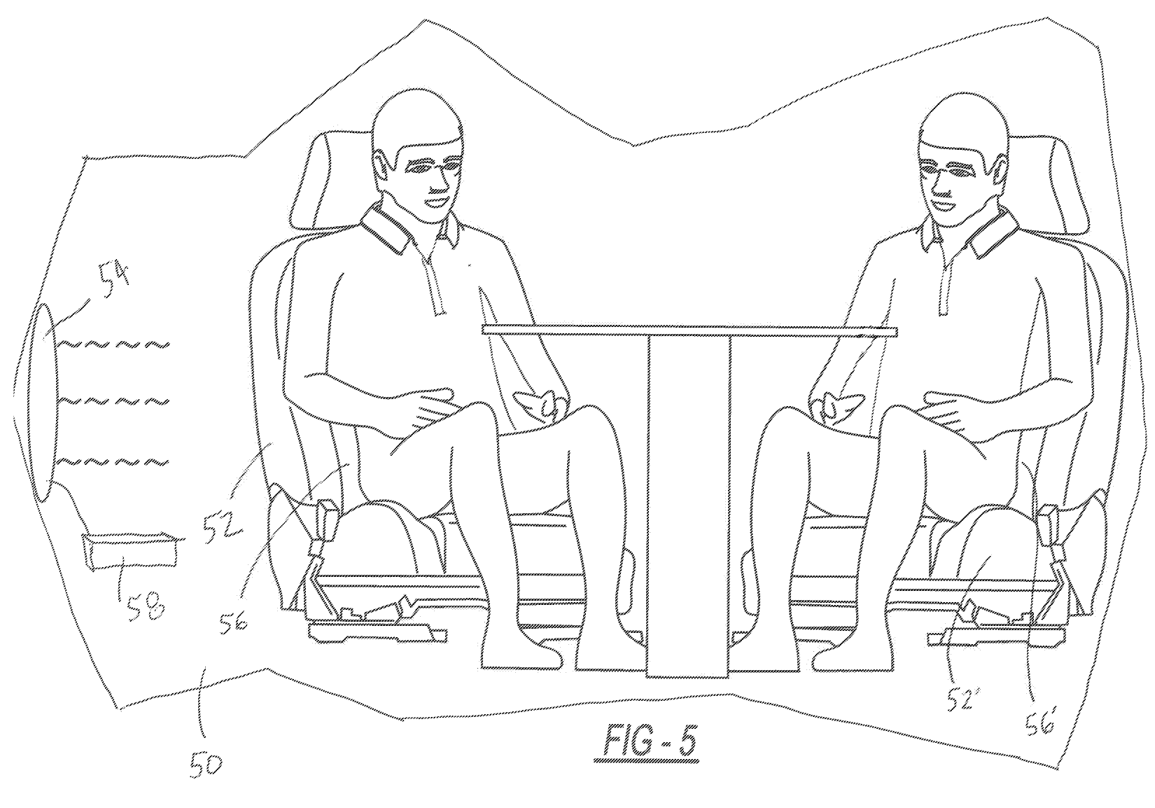

The intelligent controller 20 of the disclosed inventive concept includes algorithms that enable the thermal system to make power management predictions for maximum system efficiency. The intelligent controller 20 is capable of learning and can thus make decisions as to optimum interior conditions without the need for additional or repetitive operator or occupant inputs. As noted above, the intelligent controller 20 receives inputs from a number of vehicle sensors shown for illustrative but non-limiting purposes in FIGS. 4 and 5.

Referring to FIG. 4, a vehicle interior, generally illustrated as 30, is illustrated having interior seats 32, 32′, 32″ and 32′″. It is to be understood that a greater or lesser number of interior seats may be provided. One of the seats, interior seat 32″, illustrates a seated occupant “0.”

A non-limiting variety of sensors or wireless connectors are illustrated in relation to the vehicle interior 30. These sensors include, for example, an internet connector 34 and a GPS/vehicle posture connector 36. Other connectors are possible. Sensors 38 and 40 are included for sensing, for example, interior and exterior temperatures and humidity respectively. Internal video and thermal monitors, such as monitors 42, 44, and 46, determine not only vehicle seat occupancy but the position of each occupant in the seat, the identification of the occupant, and the thermal condition (warm, cold) of each occupant. With this information, the intelligent controller 20 can potentially conserve system power by, for example, not wasting conditioned airflow on unoccupied seats. Instead, the occupant sensing focuses airflow only where needed.

Referring to FIG. 5, an alternative vehicle interior, generally illustrated as 50, is illustrated having interior seats 52 and 52′. It is to be understood that a greater or lesser number of interior seats may be provided. Each of the interior seats 52 and 52′ includes a seated occupant “0.”

As is known, occupant comfort can be achieved by more ways than air convention, such as by conduction heat transfer. Conduction heat transfer is more energy efficient and has faster response than convention. Illustrated in FIG. 5, surface heating is provided by any of several radiation systems (in addition to the HVAC system) including, for example, a radiating heater 54. In addition, the interior seat 52 is fitted with a seat heating/cooling system 56 while the interior seat 52′ is fitted with a seat heating/cooling system 56′.

Energy-saving result may arise by limiting in-seat cooling and heating only to those seats that are actually occupied. To this end, a micro environmental controller, such as micro environmental controller 58, is associated with the intelligent controller 20 and controls, for example, individual seat heating, surface heating, and automatic ventilation. Each of these functions can run separately based on the different passenger conditions.

While the preferred embodiments of the disclosed inventive concept have been discussed are shown in the accompanying drawings and are set forth in the associated description, one skilled in the art will readily recognize from such discussion, and from the accompanying drawings and claims that various changes, modifications and variations can be made therein without departing from the true spirit and fair scope of the invention as defined by the following claims.

What is claimed is:

1. A method of controlling conditions within the cabin of an autonomous vehicle and maximizing power utilization, the method including the steps of:
forming a thermal system including an intelligent controller, said controller including an input layer, an output layer, and an intermediate layer, said intelligent controller including software capable of learning based on selected inputs;
providing sensors, connectors, and imaging systems associated with the autonomous vehicle;
directing inputs to the intelligent controller;
causing the intelligent controller to make a decision based on acquired knowledge and learned responses regarding power consumption and cabin conditions; and
outputting cabin condition-impacting instructions to condition-controlling systems.

2. The method of controlling conditions within the cabin of an autonomous vehicle and maximizing power utilization of claim 1, wherein said selected inputs are selected from the group consisting of internet data and vehicle data.

3. The method of controlling conditions within the cabin of an autonomous vehicle and maximizing power utilization of claim 2, wherein said internet data is selected from the group consisting of weather report data and user account data.

4. The method of controlling conditions within the cabin of an autonomous vehicle and maximizing power utilization of claim 2, wherein said vehicle data is selected from the group consisting of global positioning (GPS) data, vehicle posture data, vehicle identification, vehicle speed, ambient external temperature, cabin temperature, ambient external humidity, cabin humidity, user settings, and interior condition data.

5. The method of controlling conditions within the cabin of an autonomous vehicle and maximizing power utilization of claim 2, further including data inputs selected from the group consisting of solar radiation (as determined by triaxle coordinates [3D axis]), vehicle cabin and occupant positions (both by way of 3D axis space determination), occupant thermal distribution (by way of 2D imaging), cabin temperature distribution, cabin humidity, and batter power demands.

6. The method of controlling conditions within the cabin of an autonomous vehicle and maximizing power utilization of claim 1, wherein said sensors, connectors, and imaging systems include both external components and interior components.

7. The method of controlling conditions within the cabin of an autonomous vehicle and maximizing power utilization of claim 6, wherein said external components are selected from the group consisting of temperature sensors, humidity sensors, internet connectors, and GPS/vehicle posture connectors.

8. The method of controlling conditions within the cabin of an autonomous vehicle and maximizing power utilization of claim 6, wherein said interior components are selected from the group consisting of temperature sensors, humidity sensors, and seat occupancy sensors.

9. The method of controlling conditions within the cabin of an autonomous vehicle and maximizing power utilization of claim 8, wherein said interior components include imaging system components to determine seat occupancy, the identity of the seat occupant, and the thermal condition of the seat occupant.

10. The method of controlling conditions within the cabin of an autonomous vehicle and maximizing power utilization of claim 1, wherein said decision based on acquired knowledge and learned responses regarding power consumption and cabin conditions determines a power balance between upon desired power consumption and actual power consumption.

11. The method of controlling conditions within the cabin of an autonomous vehicle and maximizing power utilization of claim 10, wherein said determination of power balance is determined by various sensed conditions selected from the group consisting of ambient vehicle power, solar radiation power, vehicle conduct or operating power (including the power to the cabin 3D space and the power to the occupant 3D space), and battery cooling power.

11. The method of controlling conditions within the cabin of an autonomous vehicle and maximizing power utilization of claim 11, wherein said cabin condition-impacting instructions control air output flow volume, air temperature, air flow distribution, air intake volume, and regulation of energy flow.

12. A thermal control system for controlling the conditions within the cabin of an autonomous vehicle and maximizing power utilization, the thermal control system comprising:
an intelligent controller, said controller including an input layer, an output layer, and an intermediate layer, said intelligent controller defining a neural network that includes software capable of learning based on selected inputs; and
sensors, connectors, and imaging systems associated with the autonomous vehicle; and
at least one condition-adjusting output component.

13. The thermal control system of claim 12, wherein said sensors, connectors, and imaging systems include both external components and interior components.

14. The thermal control system of claim 13, wherein said external components are selected from the group consisting of temperature sensors, humidity sensors, internet connectors, and GPS/vehicle posture connectors.

15. The thermal control system of claim 14, wherein said interior components are selected from the group consisting of temperature sensors, humidity sensors, and seat occupancy sensors.

16. The thermal control system of claim 15, wherein said interior components include imaging system components to determine seat occupancy, the identity of the seat occupant, and the thermal condition of the seat occupant.

17. A thermal control system for controlling the conditions within the cabin of an autonomous vehicle and maximizing power utilization, the thermal control system comprising:
an intelligent controller, said controller including an input layer, an output layer, and an intermediate layer, said intelligent controller defining a neural network that includes software capable of learning based on selected inputs; and
sensors, connectors, and imaging systems associated with the autonomous vehicle, said sensors, connectors, and imaging systems include both external components and interior components; and
at least one condition-adjusting output component.

18. The thermal control system of claim 17, wherein said external components are selected from the group consisting of temperature sensors, humidity sensors, internet connectors, and GPS/vehicle posture connectors.

19. The thermal control system of claim 18, wherein said interior components are selected from the group consisting of temperature sensors, humidity sensors, and seat occupancy sensors.

20. The thermal control system of claim 19, wherein said interior components include imaging system components to determine seat occupancy, the identity of the seat occupant, and the thermal condition of the seat occupant.
